(19) United States
(12) Patent Application Publication
(10) Pub. No.: US 2004/0142704 A1
(43) Pub. Date: Jul. 22, 2004

(54) System and method of localization

(76) Inventor: Frank Michael Scholz, Carimate (IT)

Correspondence Address: Siemens Corporation, Intellectual Property Department, 170 Wood Avenue South, Iselin, NJ, 08830, US

(21) Appl. No.: 10/722,026

(22) Filed: Nov. 25, 2003

Related U.S. Application Data
(63) Continuation of application No. 10/403,441, filed on Mar. 31, 2003, now abandoned.

(30) Foreign Application Priority Data
Oct. 31, 2002 (EP) 02024265.7
Nov. 4, 2002 (WO) PCT/EP02/12292

(51) Int. Cl. H04H 1/00

(52) U.S. Cl. 455/456.1; 455/404.1; 455/404.2; 455/3.05

(57) ABSTRACT

A system and method for locating a communication device is provided wherein the communication device detects at least one accessible communications network, selects one of the accessible communications networks, and sends an emergency signal over the selected network. The plurality of communications networks may comprise a cellular network, at emergency location network, or both.

### BACKGROUND OF THE INVENTION

1. Field of the Invention

This invention generally relates to mobile communications systems and, more particularly, to providing a method and system for localization of a communication device that is part of a mobile communication system and response.

2. Description of the Related Art

The demand for security is rapidly growing and thus advanced technology in communications, safety, and security systems is required in order to maintain, track and respond to alarm signals. A wide variety of emergency call systems has been implemented, including direct connected, i.e. hard wired systems, and wireless systems.

If an emergency call is made, often a localization of the communication device (e.g., a cell phone) and its respective user is desirable. Within communications systems various methods for determining a position are known, such as using the cell identification (cell ID), or localization methods within a cell, e.g. E-OTD (Enhanced Observed Time Difference).

However, to make use of emergency call systems with such localization methods, it is necessary to be connected to the respective cellular network. In other words, no emergency signal can be received if no compatible network is available.

### SUMMARY OF THE INVENTION

It is therefore an object of the invention to provide a method and system for sending an emergency signal from a communication device, regardless of the respective cellular network connection.

It is another object of the invention to provide a method and system to switch a cellular communication device normally connected to a cellular network to a different network.

It is yet another object of the invention to provide a system and method for an alternative means for localization of a communication device, rather than using the communications system to which the device is normally connected.

It is yet another object of the invention to provide a method for selecting a network out of a plurality of available networks for sending an emergency signal.

It is yet another object of the invention to provide a system to take appropriate action in response to an emergency signal, wherein the system is the result of relationships among the end user, a safety control center, a carrier, and/or an emergency entity, and payments transferred.

A communications network is selected and an emergency signal is sent over the selected network. According to a preferred embodiment of the invention, the selected communications network is one of a plurality of communications networks that comprises an emergency location transmitter (ELT) network, e.g. an airborne or other safety network, which may exist independently from a normal cellular communications network. According to another or the same preferred embodiment of the invention one of the plurality of communications networks is a cellular network.

Upon activating an emergency call routine at a communication device, a module for broadcasting over the safety network can be enabled, if a cellular network is not available. An example of broadcasting is transmission to all stations within the safety network in the range of the communication device.

Two cases are presented for illustration. In the first case, a cellular network is available. In a preferred embodiment an emergency call procedure is performed by using the cellular network while additional services, e.g. a more accurate localization, can be requested optionally from a suitable instance of the safety network, e.g. a safety control center.

In the second case, no cellular network is available. In this case an emergency call procedure is performed by using a safety network.

In either case, the safety control center takes appropriate action to respond. This action, and the resources dedicated to it, are based on a set of relationships among the user, the safety center, and/or at least one emergency entity.

### BRIEF DESCRIPTION OF THE DRAWINGS

The foregoing and other objects, aspects and advantages will be better understood from the following detailed description of preferred embodiments of the invention with reference to the accompanying drawing, in which:

FIG. 1 is an example of an embodiment of a communication device configured to make emergency calls by pushing only one button;

FIG. 2 is an example of a schematic block diagram showing the relationship between user, network providers and safety control centers in the case of public sponsorship of the emergency system; and

FIG. 3 shows a similar diagram for private and public sponsorship.

FIG. 4 shows an example of a preferred embodiment for an emergency routine.

FIG. 5 shows an example of an alternative preferred embodiment for an emergency routine.

### DETAILED DESCRIPTION

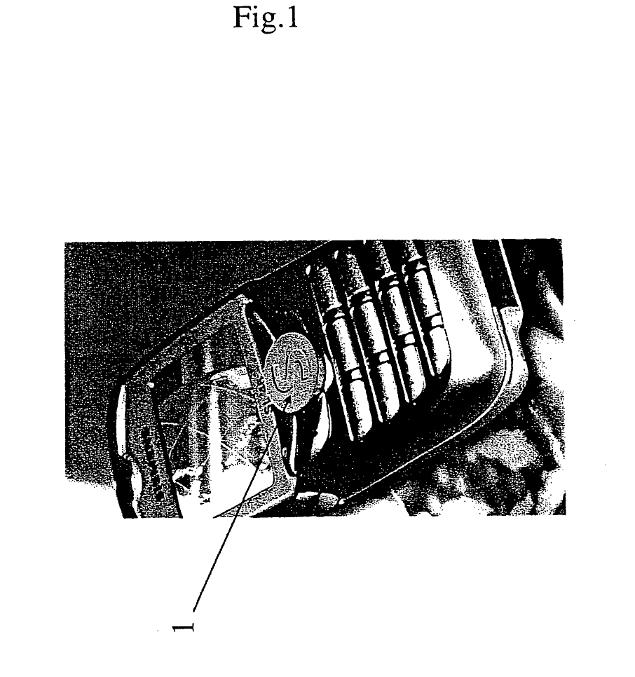

With reference to a preferred embodiment illustrated in FIG. 1, help can be reached by just pushing one single button 1 in a communication device that is widely used in a preferred embodiment, e.g. a cell phone or other mobile communication device. For the purposes of this invention, a mobile device is one that is capable of being carried by a person. In a preferred embodiment the communication device is a cell phone having a standard cell phone housing, and in an alternative preferred embodiment the communication device is any other kind of mobile equipment that allows a connection to a communications network to be established. For example, the communication device may be in the form of a device that can be worn, applied, or implanted.

The button 1 initiates an emergency call routine, by which an emergency call is performed using or utilizing a network that is determined by the routine. Although the phone may have other means by which to call public emergency services (e.g., dialing 911) over a normal cellular network, for the purposes of this invention an emergency call is distinct from a 911-type call. Thus a safety system, preferably a world-wide safety system, can be contacted by the communication device, even if there is no cellular communications network. Examples of cellular communications network includes networks based on technologies such as GSM (Global System for Mobile Communications), TDMA/CDMA (Time Division Multiple Access / Code Division Multiple Access) based networks, UMTS (Universal Telecommunications System), and WLAN (Wireless Local Area Network) Systems.

Access to a world-wide safety system is desirable as there is increased awareness for the need for safety anywhere in the world, and a need to conform to E911 legislation in certain jurisdictions. Wide availability can be achieved by using cell phones or other generally available and preferably low-cost communication devices.

Examples of emergency or global safety networks are described in greater detail below, and the primary purpose of such networks is for emergencies. Typical safety networks may exist independently from any cellular network and are based on, for example, airborne objects and/or satellites and/or radio beacons. In the case of beacons, in a preferred embodiment they can be operated as transponders and/or transmitters, may be mobile, and are referred to as a network with mobile transmitter stations or an emergency network in the framework of the present application. Mobile beacons can be placed on moving objects, e.g. on aircraft or vessels at sea.

By law in many countries, civil and military aircraft must carry an emergency location transmitter (ELT) on board. The ELT typically begins transmitting when it is activated by a sudden change in velocity caused by an aircraft crash. When another aircraft or satellite receives an emergency signal it transfers information about the crash location to the respective air search and rescue centers. Generally, aircraft and satellites are able to receive signals from an emergency radio beacon and relay them to ground stations, which process the signals to determine where the beacon is located. The ground stations then relay this information to search and rescue authorities. Such a system comprises four parts: emergency radio beacons, which call for help; aircraft and satellites to receive the calls and pass them on to ground stations; ground stations, which also receive messages; and safety control centers, which initiate an emergency response.

In a preferred embodiment, the emergency radio beacon provides two functions: if somebody is in distress in a remote area that person can make an emergency call and, secondly, by doing so information is provided about his or her location. There are different types of users of radio beacons, which may have different frequency allocations and be subject to different regulations. For example, some emergency systems use frequencies around 121.5 MHz or around 406 MHz, others may use a lower frequency, such as one that is between 2 and 10 MHz. Aircraft normally have an emergency location transmitter (ELT). Sea-faring vessels use an emergency position indicating radio beacon (EPIRB). Personal locator beacons (PLB) are generally used while engaging in land activities such as hiking or camping in the wilderness. The radio beacons can transmit signals on certain emergency frequencies normally located in (but not limited to) the VHF (Very High Frequency) region between a hundred and a few hundred MHz. Signals from a beacon are detected by airborne objects or satellites or can be repeated by another beacon, e.g. carried by aircraft passing by, which is then functioning as a transponder.

In a preferred embodiment, one emergency network is used for identification and localization. For example, features of the proven ELT (Emergency Location Transmitter) technology may be used. Identification of a communication device or its respective user may be based on the telephone number, the IMEI (International Mobile Equipment Identity), or other identifying features.

In a preferred embodiment an airborne network comprises not only a network provided by satellites, but also a network based upon satellites in combination with transponders or transmitters placed in aircrafts or vessels.

An ELT activator suitable for a communication device may consist of a detector sensitive to acceleration/deceleration, smoke, pressure, temperature or various other environmental parameters. An ELT activator may detect certain personal parameters, which provide indications regarding a person's state of health.

The various embodiments of the invention provide advantages for a safety cell phone. ELT modules, which are customary in air or vessel traffic, may be integrated with cell phone technology and integrated within a standard cell phone housing. In a preferred embodiment, the module is electronically connected and/or integrated into the phone. An antenna that is separate from the normal communications antenna is used for emergency signaling, for example to broadcast ELT signals at predefined emergency frequencies.

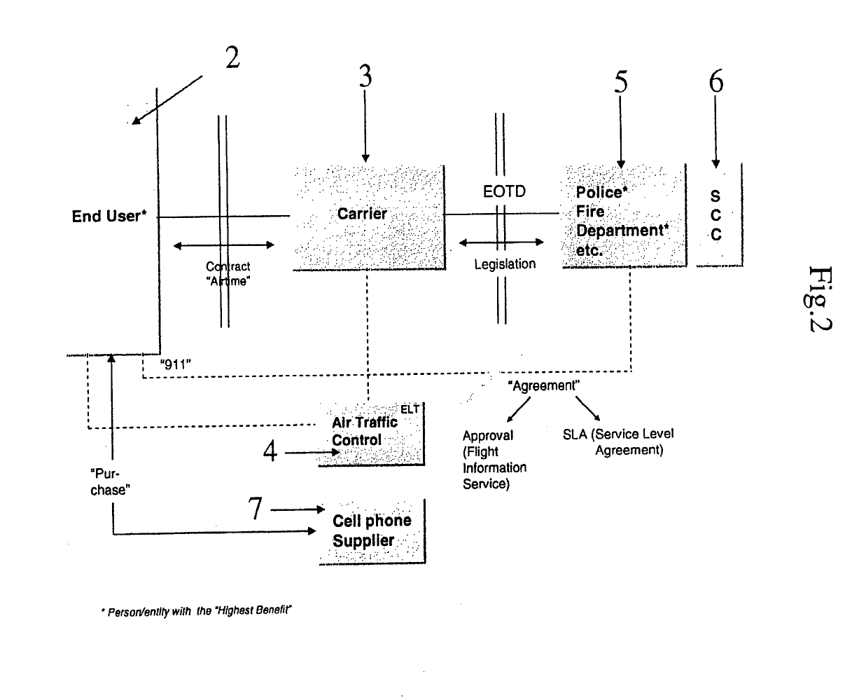

In FIG. 2 a schematic drawing of the relationship between users, network providers (carriers) and other parties in a preferred embodiment is shown. The end user 2 purchases a cell phone through a contract with supplier 7. The contract may be part of a cellular communications package that includes emergency services. The end user 2 may access the ELT network (such as air traffic control) 4 via his or her ELT module. The end user 2 can reach emergency entity 5 such as police, fire department, etc. via an emergency number, e.g. 911. The end user 2 can have a normal cellular communications network connection provided by the carrier 3 of the respective cellular communications network. The carrier 3 provides data about localization, e.g. using Enhanced Observed Time Difference (EOTD) technology per legislated guidelines, to the emergency entity 5. The emergency entity 5, which may be part of the safety control center 6, may have access to more exact ELT localization data provided by air traffic control 4.

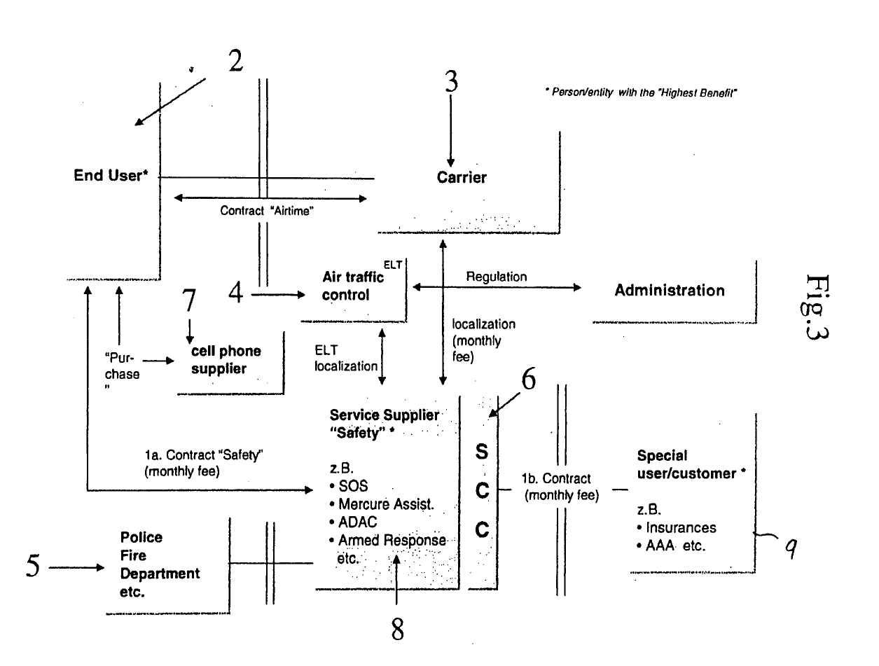

In FIG. 3 a schematic diagram of relationships is shown where safety control center 6 is sponsored by both the private and public sector. The end user 2 can, as before, purchase cell phone through a contract with supplier 7 and use carrier 3. The end user 2 can have a safety contract with a safety service supplier 8, e.g. a provider of emergency assistance, or special service supplier 9 (such as an automobile association). Safety service supplier 8 may be affiliated to the service control center 6 and be in contact with emergency entity 5. As before, the safety control center 6 may have a connection to air traffic control 4 and carrier 3, who can provide localization information.

The above-mentioned safety control center may offer a 24 hour year-round service, voice communication in the most commonly used languages of the respective area, a direct interface to emergency operators or cellular network providers, and access to personal or health data of any cell phone owner. The safety control center may be a public or private body.

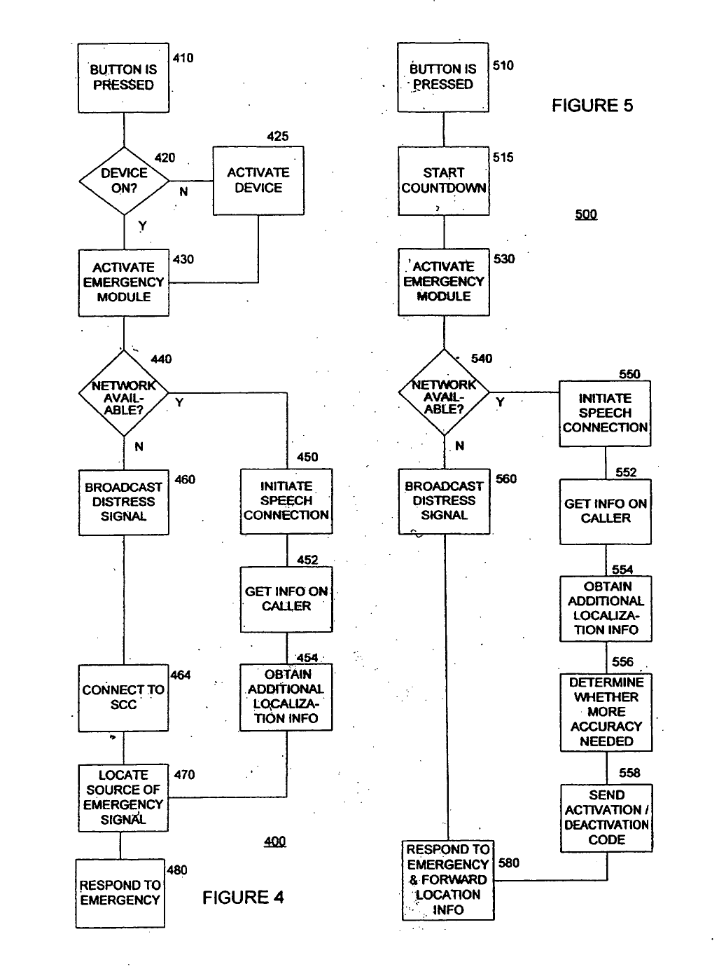

An example of the aspect of a preferred embodiment of the invention for performing the emergency routine 400 is described with reference to FIG. 4.

A security button 1 is pushed 410. This activates an emergency call routine. The emergency call routine comprises some or all of the following steps:

The communication device is checked 420 to see if it is on. In case the communication device is switched off it activates 425 the communication device. If (or as soon as) the communication device is switched on, a module for broadcasting over the emergency network, which may operate on frequencies distinct from those of the cellular communication network, is activated 430. In a preferred embodiment, this activation occurs regardless of whether it is possible to connect to a cellular communication network. Activation of the module for broadcasting may mean immediate enabling of the module in a preferred embodiment; in an alternative preferred embodiment it starts a countdown period after which the module is enabled. The module may be referred to as an ELT module, and the respective activator as the ELT activator. The ELT module is normally off during regular operation of the communication device in order to reduce power consumption.

It is then determined 440 whether a connection to a cellular communications network is available or not, and the next action depends on this determination:

If a cellular communications network is available: In case it is possible to connect to a cellular network, the activation of the emergency call routine initiates a speech connection 450, which is established via the cellular communications network to a safety control center (SCC). A further identification and localization 452 of the caller is done via the speech connection (descriptions of the user) or automatic methods of the cellular network, for example by using the cell identifier or E-OTD. Additionally, a predefined routine may be started for providing additional localization information 454, e.g. using localization methods of the emergency network.

If no cellular communications network is available: An emergency procedure is performed via the emergency network, e.g. the communication device broadcasts 460 an ELT signal which is received by an emergency network, e.g. an airborne network. The emergency network attempts to connect to a safety control center 464; alternatively, a receiving station informs the safety control center and/or rescue and help services.

In both situations (i.e., whether or not a cellular communications network is available), the transmitter of the emergency signal or the user of the communication device is located 470 accurately via radio and/or cellular communications network bearing. The safety control center takes further action to respond to the emergency 480, such as coordinating with other service suppliers, e.g. an automobile association or police or fire department.

The procedure described above provides means, if available, to locate distressed persons via a cellular network, e.g. GSM, and/or emergency signals (e.g., ELT signals) from a cell phone. A voice connection can also be established via the cellular network if available. A safety control center is used to contact help.

An alternative preferred embodiment for an emergency routine 500 is shown in FIG. 5. Safety button 1 is pressed 510. An emergency routine is started within the communication device: an ELT activity countdown 515 is started within the communication device, regardless of any network connection. After the ELT activity countdown the ELT module is activated 530. A determination 540 is made whether connection can be made to a cellular communications network.

In the case where a connection to a cellular communications network can be established, a cellular speech connection is made to the safety control center. The caller can report an emergency and provide further details if in condition to do so. The safety control center tries to identify the caller, the nature of the problem and may retrieve medical data on the caller 552. Additionally, the safety control center attempts to determine geographical coordinates 554, e.g. via voice and/or cellular communication network data, for example by using the cell identifier or E-OTD. As the spatial resolution of localization methods within a cellular communications network is limited, it is decided 556 by the safety control center whether an ELT search is necessary to achieve an enhanced localization. Having made this determination, the safety control center may transmit 558 an ELT activation or deactivation code to the cell phone.

In the case where a connection to a cellular communications network cannot be established, the ELT distress signal is automatically broadcast 560.

Whether or not a cellular communication could be established, emergency procedures are put into motion by the safety control center—for example, informing the police, the fire department, ambulance, air rescue, etc. and the safety control center may submit location data 580 to search and rescue forces with a link to the activated ELT signal or by supporting them without ELT guidance.

A preferred embodiment of a communication device capable of making an emergency call comprises typically a safety or security button 1, which by being pushed activates the emergency call routine. Furthermore, the communication device comprises an ELT module which allows the communication device to transmit and/or transpond emergency signals. It also optionally comprises an ELT activator, which may be sensitive to deceleration or other change in state. It may further comprise an additional power supply for the ELT module, to permit longer operation of the ELT module. Other optional communication device features includes an automatic communication setup that helps during the establishment of a speech connection. A programmable automatic log-on mode allows accessing the emergency call routine even if the user is not in a position to do so manually. Preferably, the body of the communication device is shock resistant. An additional optional feature is amplification of the signal power output in emergency situations.

In an additional preferred embodiment, the safety feature of the communication device can be activated remotely in order to search for missing persons, children or cars. To prevent unwanted use of this method this feature of remote activation may depend upon the user of the communication device enabling the feature. An automatic check may be performed or a safety center search signal may be sent at predetermined time intervals, even if the power of the cell phone is switched off.

While the invention has been described in terms of preferred embodiments, those skilled in the art will recognize that the inventions can be practiced with modification within the spirit and scope of the appended claims.

1. A method of locating a mobile communication device, whereby an emergency call routine is activated, comprising the steps of:
detecting, at the location of the mobile communication device, at least one accessible communications network out of a plurality of communications networks wherein at least one of said plurality of communications networks is an emergency network;
selecting one of said at least one accessible communications network; and
sending an emergency signal over the selected network.

2. A method of locating a communication device according to claim 1, wherein at least one of the at least one accessible communications network comprises a mobile transceiver or transponder station that further transmits the emergency signal.

3. A method of locating a communication device according to claim 1, wherein at least one of said at least one accessible communications network is a cellular network.

4. A method of locating a communication device according to claim 1, wherein the emergency call routine comprises the identification of the mobile communication device.

5. A method of locating a communication device according to claim 1, further comprising establishing a speech connection over one of said at least one accessible communications network.

6. A method of locating a communication device according to claim 1, wherein the emergency call routine is activated remotely.

7. A method of locating a mobile communication device according to claim 1, detecting comprises:
attempting to contact a cellular network;
determining, based on said attempt to contact a cellular network, whether said cellular network is a said at least one accessible communications network; and
if said cellular network is a said at least one accessible communications network, attempting to contact to said emergency network.

8. A mobile communication device for initiating an emergency call routine, comprising:
a module for detecting at least one accessible communications network out of a plurality of communications networks;
a module for selecting one of said at least one accessible communications network; and
a module for sending an emergency signal over the selected network.

9. A mobile communication device according to claim 8, wherein said module for sending an emergency signal comprises at least two radio modules, one of said radio modules being manually or automatically activable.

10. A mobile communication device according to claim 8, further comprising a button for initiating said emergency call routine.

11. A mobile communication device according to claim 8, wherein said mobile communication device is a cell phone.

12. A method of initiating an emergency response, comprising the steps of:
connecting to an emergency call initiated by a mobile communication device over a first network;
obtaining information related to the user of the mobile communication device including the location of the user;
determining, based on the information obtained, whether additional localization information is needed;
utilizing a second network, wherein the second network is an emergency network, to communicate the additional localization information if it is determined that the additional localization information is needed; and
contacting an emergency entity and forwarding the additional localization information.

13. A method of initiating an emergency response according to claim 12, wherein the first network is a cellular communications network.

14. A method of initiating an emergency response according to claim 12, wherein the step of utilizing a second network to obtain the additional localization information further comprises sending an activation signal.

15. A method of initiating an emergency response according to claim 12, wherein the second network is a network that receives an emergency signal from the mobile communication device.

16. A method of obtaining emergency help, comprising the steps of:
activating an emergency module in a mobile communication device;
determining whether a connection to a first network is available;
broadcasting a distress signal over an emergency network if the first network is not available; and
initiating a speech connection over the emergency network if the first network is available.

17. A method of obtaining emergency help according to claim 16, wherein the mobile communication device is a cell phone.

18. A method of obtaining emergency help according to claim 16, wherein the emergency network is an ELT network.

19. A method of obtaining emergency help according to claim 16, wherein the step of activating an emergency module in a mobile communication device is initiated remotely from the mobile communication device.

20. A method of obtaining emergency help according to claim 16, wherein the step of activating an emergency module in a mobile communication device is initiated by a button on the mobile communication device being pressed.

21. A method for locating a mobile communication device, whereby an emergency call routine is activated, by which the following steps are performed:
detecting at least one available communications network at the location of the mobile communication device;
in case that more than one communications network exists, selecting one of the communications networks;
in case that only one communications network is available selecting this communications network; and
sending an emergency signal over the selected network.

22. The method according to claim 21, whereby at least one of the communications networks comprises mobile transceiver or transponder stations, by which the emergency signal from the communication device are further transmitted.

23. The method according to claim 21, further comprising a cellular network.

24. The method according to claim 21, whereby the emergency call routine also comprises the identification of the communication device.

25. The method according to claim 21, whereby a speech connection is established over one of the communications networks.

26. The method according to claim 21, whereby the emergency call routine can be activated remotely.

27. The communication device for performing a method according to claim 21.

28. The communication device according to claim 27, comprising at least two radio modules, one of said radio modules being manually or automatically activable.

29. The communication device according to claim 27, whereby the steps of the method can be activated by pushing one button on the communication device.

30. The communication device according to claim 27, whereby the communication device is a cellular phone.

31. A communications system comprising a communication device according to claim 27.
